(19) United States
(12) Patent Application Publication
(10) Pub. No.: US 2008/0039356 A1
(43) Pub. Date: Feb. 14, 2008

(54) Selective removal chemistries for semiconductor applications, methods of production and uses thereof

(75) Inventors: Ben Palmer, Phoenix, AZ (US); Deborah Yellowaga, Phoenix, AZ (US)

Correspondence Address: BUCHALTER NEMER, 18400 VON KARMAN AVE., SUITE 800, IRVINE, CA, 92612, US

(73) Assignee: Honeywell International Inc.

(21) Appl. No.: 11/495,942

(22) Filed: Jul. 27, 2006

(51) Int. Cl. C11D 17/00

(52) U.S. Cl. 510/424; 510/492; 510/426

(57) ABSTRACT

Removal chemistry solutions are described herein that include at least one sulfonic acid component having the formula:

R—SO₃H (Formula I)

where R comprises at least one halo group, amino group, alkyl group, alkenyl group, alkynyl group or phenylamino group having the formula C₆(NH₂)H₂XY, where X and Y may comprise at least one hydrogen, halo group, alkyl group, alkenyl group, alkynyl group, hydroxyl group, amino group or phenyl group. R may also comprise R₁R₂R₃C, where R₁, R₂ and R₃ may be the same or different and may comprise at least one hydrogen, halo group, alkyl group, alkenyl group, alkynyl group, hydroxyl group, amino group or aromatic group, and at least one solvent or solvent mixture. In some formulations, at least one fluoride source is added to the removal chemistry solution. In addition, methods are described herein of producing a removal chemistry solution that includes: providing the sulfonic acid component described above; providing at least one solvent or solvent mixture; and blending the at least one sulfonic acid component and the at least one solvent or solvent mixture to form the removal chemistry solution. In some formulations, at least one fluoride source is provided and blended with the at least one sulfonic acid component and the at least one solvent or solvent mixture to form a removal chemistry solution.

### FIELD OF THE SUBJECT MATTER

The field of the subject matter is selective removal chemistries for semiconductor, electronic and related applications, including organic anti-reflective coatings, which may be used as anti-reflective coatings. Selective removal chemistries described herein may also be used for exposed and developed photoresists and polymer sidewalls.

### BACKGROUND

To meet the requirements for faster performance, the characteristic dimensions of features of integrated circuit devices have continued to decrease. Manufacturing of devices with smaller feature sizes introduces new challenges in many of the processes conventionally used in semiconductor fabrication. Dual damascene patterning and via first trench last (VFTL) copper dual damascene patterning through a low dielectric constant (less than about 3) material or ultra low dielectric constant (less than about 2) material is one of these manufacturing methods. Two examples of dual damascene patterning and structures are shown in US Patent Publications 20040152296 and 20040150012—both assigned to Texas Instruments.

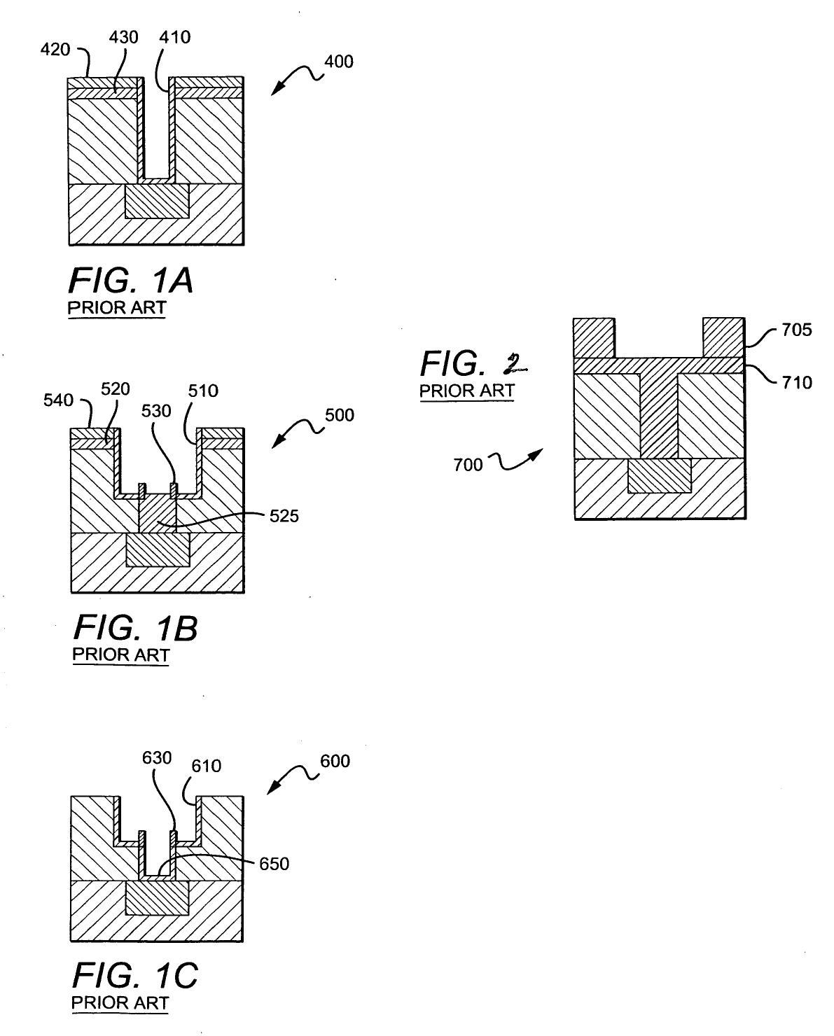

In the manufacture of MEMS (microelectromechanical systems) devices, each continuous or patterned layer comprises deleterious residues that, if left even partially intact, will contribute to the breakdown and ultimately the failure of any component that comprises that layer. Therefore, deleterious residues produced during the manufacture of semiconductor, MEMS and other electronic devices should be removed effectively and sufficiently. In addition, where one or more layers need to be etched, the etch pattern should be precise and the removal chemistry solution used should be selective to the layer being etched. Prior Art FIGS. 1A-1C show etch residues, including sidewall polymers, antireflective coatings and other residues, in a via clean (FIG. 1A), a trench clean (FIG. 1B) and an etch stop clean (FIG. 1C) application. Prior Art FIG. 1A, shows a layered material 400 that comprises a polymer sidewall 410, a photoresist layer 420 and an antireflective coating layer 430. Prior Art FIG. 1B shows a layered material 500 that comprises a polymer sidewall 510, antireflective coating 520, a via fill 525, a via fence 530, which may or may not be present depending on the integration scheme, and a photoresist 540. The via fence 230 and/or via fill 240 may or may not be present depending on the integration scheme. Prior Art FIG. 1C shows a layered material 600 that comprises a polymer sidewall 610, a via fence 630 and copper oxide and/or copper fluoride residues 650. Prior Art FIG. 2 shows a layered material 700 that comprises a UV exposed and developed photoresist 705, a BARC (Bottom Anti-Reflective Coating) 710, wherein the BARC, which may be organic or inorganic, needs to be removed without impacting critical dimensions.

The technique of bulk residue removal by means of a selective chemical etching and in some cases selective chemical cleaning is a key step in the manufacture of many semiconductor and electronic devices, including those mentioned. The goal in successful selective etching and selective cleaning steps is to remove the residue without removing or compromising the desirable components. In some cases, the “removal” of unwanted materials or residues includes reacting those unwanted materials with solutions or compounds in order to convert those unwanted materials into materials that are not harmful or have negative impact on the electronic or semiconductor applications or components.

Each class of semiconductor and electronic materials comprise different chemistries that should be considering when developing the removal chemistry and in several cases, these semiconductor and electronic materials have also been modified to increase removal selectivity, such as the etch selectivity or the cleaning selectivity. If the chemistry of the sacrificial layer cannot be modified in order to improve the removal selectivity, then removal chemistry solutions should be developed to specifically react with the chemistry of the sacrificial material. However as mentioned, not only does the chemistry of the sacrificial material need to be evaluated and considered, but the chemistry of the surrounding and/or adjacent layers should also be considered, because in many instances, the chemistry that will remove the sacrificial layer or layers will also remove or weaken the surrounding or adjacent layers.

US Publication 2005/0020463, US Publication 2004/0137736, US Publication 2003/0130148, US Publication 2003/0022800 and US Publication 2001/0025017 disclose etching and cleaning solutions used for electronic and semiconductor materials, however, these solutions are substantially aqueous in nature.

Therefore, it would be desirable to form selective removal chemistry solutions that can do at least one of the following: a) can be tailored to be a selective etching solution and/or a selective cleaning solution; b) is effective in removing organic materials, which may be used as anti-reflective coatings (including bottom coatings) and which are traditionally very difficult to remove with wet chemical processing; c) can selectively remove deleterious materials and compositions from a surface without removing the layers and materials that are crucial to product success, such as the underlying dielectric layers; d) can remove the desired materials from the surface, while at the same time minimizing or eliminating redeposition of those materials on the surface; and e) can etch and/or clean effectively at the center of the wafer or surface and at the edge of the wafer or surface.

### SUMMARY OF THE SUBJECT MATTER

Removal chemistry solutions are described herein that include: A removal chemistry solution includes at least one sulfonic acid component having the formula:

R—SO₃H (Formula I)

where R comprises at least one halo group, amino group, alkyl group, alkenyl group, alkynyl group or phenylamino group having the formula C₆(NH₂)H₂XY, where X and Y may comprise at least one hydrogen, halo group, alkyl group, alkenyl group, alkynyl group, hydroxyl group, amino group or phenyl group. R may also comprise R₁R₂R₃C, where R₁, R₂ and R₃ may be the same or different and may comprise at least one hydrogen, halo group, alkyl group, alkenyl group, alkynyl group, hydroxyl group, amino group or aromatic group, and at least one solvent or solvent mixture. In some formulations, at least one fluoride source is added to the removal chemistry solution.

In addition, methods are described herein of producing a removal chemistry solution that includes: providing the sulfonic acid component described above; providing at least one solvent or solvent mixture, and blending the at least one sulfonic acid component and the at least one solvent or solvent mixture to form the removal chemistry solution. In some formulations, at least one fluoride source is provided and blended with the at least one sulfonic acid component and the at least one solvent or solvent mixture to form a removal chemistry solution.

### BRIEF DESCRIPTION OF THE FIGURES

Prior Art FIGS. 1A-1C show etch residues in a via clean (FIG. 1A), a trench clean (FIG. 1B) and an etch stop clean (FIG. 1C) application.

Prior Art FIG. 2 shows a layered material that comprises an organic material, in this case an ARC (Anti-Reflective Coating) or BARC (Bottom Anti-Reflective Coating), wherein the organic material needs to be removed without impacting critical dimensions.

### DETAILED DESCRIPTION

To meet the requirements for faster performance, the characteristic dimensions of features of integrated circuit devices have continued to be decreased. Manufacturing of devices with smaller feature sizes introduces new challenges in many of the processes conventionally used in semiconductor fabrication. One of the most important of these fabrication processes is photolithography.

It has long been recognized that linewidth variations in patterns produced by photolithography can result from optical interference from light reflecting off an underlying layer on a semiconductor wafer. Variations in photoresist thickness due to the topography of the underlying layer also induce linewidth variations. Anti-reflective coatings (ARC) applied under a photoresist layer have been used to prevent interference from reflection of the irradiating beam. In addition, anti-reflective coatings partially planarize the wafer topography, helping to improve linewidth variation over steps because the photoresist thickness is more uniform. These anti-reflective coatings can be characterized as organic or inorganic in nature. For example, blanket and patterned organic polymer films, such as those described in U.S. Pat. No. 6,503,689, which is incorporated herein by reference in its entirety, can be used as anti-reflective coatings and bottom anti-reflective coatings. These organic materials can also be utilized for other applications, such as planarizing agents. Organic materials utilized as anti-reflective coatings can not only be difficult to use, but can also be difficult to remove by processes such as wet chemical etching.

Removal chemistry solutions for utilization with organic materials described herein include: at least one sulfonic acid component; and at least one solvent or solvent mixture. In some formulations, at least one fluoride source is added to the removal chemistry solution. In other embodiments, at least one additional component may be included in removal chemistry solutions contemplated herein.

Contemplated solutions comprise at least one sulfonic acid component, such as a alkylsulfonic acid, an alkylsulfonic anhydride or a combination thereof. Suitable alkylsulfonic acids may have the following formulas:

R—SO₃H (Formula I)

where R comprises at least one halo group, amino group, alkyl group, alkenyl group, alkynyl group or phenylamino group having the formula C₆(NH₂)H₂XY, where X and Y may comprise at least one hydrogen, halo group, alkyl group, alkenyl group, alkynyl group, hydroxyl group, amino group or phenyl group. R may also comprise R₁R₂R₃C, where R₁, R₂ and R₃ may be the same or different and may comprise at least one hydrogen, halo group, alkyl group, alkenyl group, alkynyl group, hydroxyl group, amino group or aromatic group, and at least one solvent or solvent mixture. In some formulations, at least one fluoride source is added to the removal chemistry solution.

Contemplated removal chemistry solutions described herein are especially beneficial, because they have flash points greater than at least about 200° F. In some embodiments, these solutions have flash points greater than at least about 225° F. In other embodiments, these solutions have flash points greater than at least about 250° F. Also, contemplated removal chemistry solutions have a pH of less than about 5. In some embodiments, contemplated removal chemistry solutions have a pH of less than about 4.8. In other embodiments, contemplated removal chemistry solutions have a pH of less than about 4.5. In yet other embodiments, contemplated removal chemistry solutions have a pH of less than about 4.2.

Applying these formulas as contemplated herein, suitable sulfonic acids may include methanesulfonic acid, ethanesulfonic acid, propanesulfonic acid, fluorosulfonic acid, trifluoromethanesulfonic acid, nonafluorobutanesulfonic acid, sulfanilic acid, sulfamic acid, aminomethanesulfonic acid, benzenesulfonic acid, morpholine ethanesulfonic acid, morpholine propanesulfonic acid, camphor-10-sulfonic acid, diphenylamine-4-sulfonic acid, hydroxylamine-O-sulfonic acid, 4-hydroxy-3-nitroso-1-napthalenesulfonic acid, 5-amino-1-napthalenesulfonic acid, 4-aminotoluenesulfonic acid, 3-hydroxypropane-1-sulfonic acid, 4-amino-1-napthalenesulfonic acid, 4-amino-3-hydroxy-1-napthalenesulfonic acid, 1-aminoanthaquinone-2-sulfonic acid, p-xylenen-2-sulfonic acid, piperidine-4-sulfonic acid or combinations thereof.

In some embodiments, the sulfonic acid component may also comprise alkylsulfonic anhydrides, which more specifically, may include methanesulfonic anhydride, trifluoromethanesulfonic anhydride or combinations thereof.

The at least one sulfonic acid component is added to at least one solvent or solvent mixture. Contemplated solvents include any suitable pure or mixture of organic or inorganic molecules that are volatilized at a desired temperature, such as the critical temperature, or that can facilitate any of the above-mentioned design goals or needs. The solvent may also comprise any suitable pure or mixture of polar and non-polar compounds. As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound. One of ordinary skill in the art of chemistry and etching solutions will know which solvents are non-polar and which solvents are clearly polar in nature.

The solvent or solvent mixture (comprising at least two solvents) may comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosine, isobutylbenzene, methylnaphthalene and ethyltoluene.

The solvent or solvent mixture may comprise those solvents that are not considered part of the hydrocarbon solvent family of compounds, such as ketones, such as acetone, diethyl ketone, methyl ethyl ketone and the like, alcohols, esters, ethers and amines. Other contemplated solvents include propylene carbonate, butylene carbonate, ethylene carbonate, gamma-butyrolactone, propylene glycol, ethyl lactate, propylene glycol monomethyl ether acetate or a combination thereof. In yet other contemplated embodiments, the solvent or solvent mixture may comprise a combination of any of the solvents mentioned herein.

The at least one solvent or solvent mixture may be those solvents that contain nitrogen atoms, phosphorus atoms, sulfur atoms or a combination thereof, such as N-methyl-2-pyrrolidone, N,N-dimethylacetamide, dimethyl sulfoxide, pyridine or a combination thereof. Both the etching and the cleaning solutions contemplated herein also utilize a compatible solvent constituent.

Solvents and solvent mixtures may be present in solution in an amount less than about 99.5% by weight. In some embodiments, the solvents or solvent mixtures may be present in solution in an amount from about 30% to about 99.5% by weight.

The solvents used herein may comprise any suitable impurity level, such as less than about 1 ppm, less than about 100 ppb, less than about 10 ppb, less than about 1 ppb, less than about 100 ppt, less than about 10 ppt and in some cases, less than about 1 ppt. These solvents may be purchased having impurity levels that are appropriate for use in these contemplated applications or may need to be further purified to remove additional impurities and to reach the less than about 10 ppb, less than about 1 ppb, less than about 100 ppt or lower levels that are becoming more desirable in the art of etching and cleaning.

In some embodiments, at least one fluoride source may be added to the removal chemistry solution. The at least one fluoride source may comprise any suitable fluoride source, such as R₁R₂R₃R₄NF, where R₁, R₂, R₃ and R₄ can be the same or different and can be H or any hydrocarbon moiety of 10 or less carbon units and may be aliphatic, aromatic or cyclic, such as ammonium fluoride, tetramethylammonium fluoride, tetrabutylammonium fluoride, tetraethylammonium fluoride or benzyltrimethylammonium fluoride; hydrogen fluoride, pyridine hydrogen fluoride, ammonium bifluoride or combinations thereof. Hydrogen fluoride may be obtained from suitable sources, such as 49% aqueous hydrogen fluoride, anhydrous hydrogen fluoride gas or pyridinium hydrogen fluoride. Anhydrants, such as acetic anhydride, citroconic anhydride, propionic anhydride, glutartic anhydride or combinations thereof, may be utilized in order to remove water from the fluoride source, if necessary.

The at least one fluoride source may be added in any suitable manner, including bubbling a gas comprising the fluoride source into the at least one solvent or solvent mixture or blending the fluorine-based constituent into the at least one solvent or solvent mixture. In one contemplated embodiment, anhydrous hydrogen fluoride gas is bubbled into desired solvent or mixture of solvents.

The at least one fluoride source may be present in solution in an amount less than about 5% by weight. In some embodiments, the fluorine-based constituents are present in solution in an amount from about 0.005% to about 5 % by weight. In other embodiments, the fluorine-based constituents are present in solution in an amount from about 0.005% to about 4% by weight. In yet other embodiments, the fluorine-based constituents are present in solution in an amount from about 0.005% to about 3% by weight. And in some embodiments, the fluorine-based constituents are present in solution in an amount from about 0.005% to about 2% by weight.

As mentioned, contemplated methods of producing a removal chemistry solution include: providing at least one sulfonic acid component; providing at least one solvent or solvent mixture; and blending the at least one sulfonic acid component and the at least one solvent or solvent mixture to form the removal chemistry solution. In some formulations, at least one fluoride source is provided and blended with the at least one sulfonic acid component and the at least one solvent or solvent mixture to form a removal chemistry solution.

Additional components may be added to the at least one solvent or solvent mixture, the at least one sulfonic acid component and/or the removal chemistry solutions produced initially. For example, it may be desirable to dissolve into the solvent constituents components that are nitrogen-containing species, including chelators or NH₃. Some of these components are solids at ambient conditions such as amine chelators (e.g. hexamethylenetetramine, EDTA), and when utilizing these components, unique amine-HF adducts may be formed during anhydrous hydrogen fluoride gas addition, if used. Water may also be an additional component that is desirable in contemplated solutions.

Chelating agents, such as an organic acid (acetic acid, citric acid, lactic acid, oxalic acid, tartaric acid, gluconic acid, iminodiacetic acid, succinic acid, malic acid, maleic acid or a combination thereof), an amine(hexamethylenetetramine, triethanolamine, nitrilotriacetic acid, tris(2-pyridylmethyl)amine, EDTA), phosphonates and alkylphosphonic acids, such as diamyl amylphosphonate, bis(2-chloroethyl)methyl phosphonate, dibutyl butylphosphonate, diethyl benzylphosphonate, nitrilotris(methylene)triphosphonic acid, hydroxyethylidenediphosphonic acid, sulfonic acid, such as 3-(N-tris[hydroxymethyl]methylamine)-2-hydroxypropanesulfonic acid, 3([1,1-dimethyl-2-hydroxyethyl)amine]-2-hydroxypropanesulfonic acid, 1,2,4,5-benzenetetracarboxylic acid, THF-tetracarboxylic acid, trifluoroacetic acid, N-(2-(acetamido)imino)diacetic acid, H₃PO₄ or combinations thereof of any of the above chelating agents may also be added to the at least one solvent or solvent mixture, the at least one sulfonic acid component and/or the removal chemistry solutions.

The chelator may be dissolved directly into the first solvent or solvent mixture pre or post addition of the at least one sulfonic acid constituent, or if the chelator has low solubility in the first solvent or solvent mixture, can first be dissolved in an appropriate co-solvent prior to addition to first solvent or solvent mixture. In some embodiments, chelating agents comprise metal chelating agents. As contemplated herein, the at least one chelating agent may be present in solution in an amount less than about 20% by weight. In some embodiments, the at least one chelating agent may be present in solution in an amount from about 0.001% to about 20% by weight. In some embodiments, at least two chelating agents may be present in solution.

Oxidizing agents, such as hydrogen peroxide (aq), ozone (bubbled), urea hydrogen peroxide, benzoyl peroxide, peroxyacetic acid (and halogenated peroxyacetic acids), peroxybenzoic acid, 2-butanone peroxide, t-butylhydroperoxide, 2,4-pentanedione peroxide, m-chloroperbenzoic acid or combinations thereof and other organic peroxides may also be added to the at least one solvent or solvent mixture and/or the removal chemistry solutions produced initially. The oxidizing agent may be dissolved directly into the first solvent or solvent mixture pre or post addition of the at least one sulfonic acid constituent, or if the oxidizing agent has low solubility in the first solvent or solvent mixture, can first be dissolved in an appropriate co-solvent prior to addition to first solvent or solvent mixture. It is contemplated that some of the oxidizing agents may be anhydrous. As contemplated herein, the at least one oxidizing agent may be present in solution in an amount less than about 20% by weight. In some embodiments, the at least one oxidizing agent may be present in solution in an amount from about 0.001% to about 20% by weight. In some embodiments, at least two oxidizing agents may be present in solution.

A surfactant may be added to the at least one solvent or solvent mixture, the at least one sulfonic acid component and/or the removal chemistry solutions produced initially to lower surface tension. As used herein, the term “surfactant” means any compound that reduces the surface tension when dissolved in H₂O or other liquids, or which reduces interfacial tension between two liquids, or between a liquid and a solid. Contemplated surfactants may include at least one anionic surfactant, cationic surfactant, non-ionic surfactant, Zwitterionic surfactant or a combination thereof. The surfactant may be dissolved directly into the first solvent or solvent mixture pre or post addition of the at least one sulfonic acid constituent, or if the surfactant has low solubility in the first solvent or solvent mixture, can first be dissolved in an appropriate co-solvent prior to addition to first solvent or solvent mixture. Contemplated surfactants may include: sulfonates such as dodecylbenzene sulfonate, tetrapropylenebenzene sulfonate, dodecylbenzene sulfonate, a fluorinated anionic surfactant such as Fluorad FC-93, and L-18691 (3M), fluorinated nonionic surfactants such as FC-4430 (3M), FC-4432 (3M), and L-18242 (3M), quaternary amines, such as dodecyltrimethylammonium bromide or cetyltrimethylammonium bromide, alkyl phenoxy polyethylene oxide alcohols, alkyl phenoxy polyglycidols, acetylinic alcohols, polyglycol ethers such as Tergitol TMN-6 (Dow) and Tergitol minifoam 2× (Dow), polyoxyethylene fatty ethers such as Brij-30 (Aldrich), Brij-35 (Aldrich), Brij-58 (Aldrich), Brij-72 (Aldrich), Brij-76 (Aldrich), Brij-78 (Aldrich), Brij-98 (Aldrich), and Brij-700 (Aldrich), betaines, sulfobetaines, such as cocoamidopropyl betaine, and synthetic phospholipids, such as dioctanoylphosphatidylcholine and lecithin and combinations thereof. As contemplated herein, the at least one surfactant may be present in solution in an amount less than about 5% by weight. In some embodiments, the at least one surfactant may be present in solution in an amount from about 0.001% to about 5% by weight. In some embodiments, at least two surfactant constituents may be present in solution.

In yet other embodiments, the removal chemistry solution may comprise at least two chelating agents/constituents, oxidizing agents/constituents, surfactants or a combination thereof. In some of these embodiments, the removal chemistry may comprise a chelating agent and an oxidizing agent or a chelating agent and a surfactant or an oxidizing agent and a surfactant. In other embodiments, the removal chemistry may comprise at least two chelating agents and an oxidizing agent and/or surfactant, for example. These examples should provide information to one of ordinary skill in the art that one or more of these additives can be incorporated into the removal chemistry solution alone or in combination.

The at least one sulfonic acid component, the at least one fluoride source, the at least one solvent or solvent mixture and/or any other constituent/additive mentioned herein may be provided by any suitable method, including a) buying at least some of the at least one sulfonic acid component, the at least one fluoride source, the at least one solvent or solvent mixture and/or any other constituent/additive mentioned herein from a supplier; b) preparing or producing at least some of the at least one sulfonic acid component, the at least one fluoride source, the at least one solvent or solvent mixture and/or any other constituent/additive mentioned herein in house using chemicals provided by another source and/or c) preparing or producing at least some of the at least one sulfonic acid component, the at least one fluoride source, the at least one solvent or solvent mixture and/or any other constituent/additive mentioned herein in house using chemicals also produced or provided in house or at the location.

In one contemplated embodiment, the at least one fluoride source is added to the at least one solvent or solvent mixture and the at least one sulfonic acid constituent to form the removal chemistry solution. HF_{(g)} can be bubbled into the at least one solvent or solvent mixture and the at least one sulfonic acid constituent until desired weight percent (wt %) concentration is reached, which may include the saturation point of HF_{(g)} in the solvent(s). Alternately, hydrogen fluoride gas can be gassed into a first solvent and/or sulfonic acid component, and then another solvent or solvent mixture may be dissolved into the first solvent post HF_{(g)} addition.

As mentioned, once the at least one sulfonic acid component and the at least one solvent or solvent mixture constituent are provided, they are blended to form a solution, wherein the solution constituents are at a suitable concentration to etch and/or clean organic materials, including sacrificial layers, modified sacrificial layers and/or patterns of both of these compositions from a surface without significantly reacting with any adjacent and/or corresponding layers, such as dielectric layers, hard mask layers, metal layers, etc. The removal chemistry solutions contemplated herein can be custom blended for specific applications; however, it is contemplated that the process of custom blending does not require undue experimentation once the disclosure herein, including the stated goals, is understood by one of ordinary skill in the art of etching solutions for electronic and semiconductor applications.

The removal chemistry solutions contemplated herein can selectively remove organic polymer films, which comprise materials that may be used as anti-reflective coatings, such as bottom anti-reflective coatings, at a rate of at least 70 Å/minute. Other contemplated removal chemistry solutions can selectively remove organic polymer films at a rate of at least 90 Å/minute. Some contemplated removal chemistry solutions can selectively remove organic polymer films at a rate of at least 120 Å/minute. In some embodiments, removal chemistry solutions can selectively remove organic polymer films at a rate of at least 150 Å/minute. In other embodiments, removal chemistry solutions can selectively remove organic polymer films at a rate of at least 200 Å/minute. In yet other embodiments, removal chemistry solutions can selectively remove organic polymer films at a rate of at least 250 Å/minute. Table 1 in the Examples Section shows how these selective etch and removal rates can be compared to inorganic films such as OSG and TEOS-based films and layers. It is instructive to note that it is likely that the removal rate of contemplated organic polymer films exceeds at least 250 Å/minute, primarily because the removal rates for the study shown in Table 1 were based on a 10 minute measurement cycle. The organic polymer films tested may have been completely selectively removed after only a couple of minutes, as compared to the OSG and TEOS films, which would result in greatly increased selective removal rates.

The inorganic films and layers, such as thermal oxide, TEOS and CVD OSG, that can be utilized with the organic polymer films disclosed herein, are generally applied by vapor deposition and are similar to or the same as those compounds manufactured by Honeywell International Inc. These materials can also be provided by other companies. For example, the TEOS-based films and HSQ films may be manufactured in-house at Honeywell International, Inc or provided by other companies. Thermal oxide and OSG films may be provided by customers or other vendors, such as Novellus (CORAL™) or Applied Materials (BLACK DIAMOND™). In some embodiments, for example, TEOS films may comprise a thickness of around 1000 Å, TOx films may comprise a thickness of about 9000 Å and OSG films may comprise a thickness of about 4000 Å.

These materials that may be used on wafers and layered materials comprise inorganic-based compounds, such as silicon-based compounds. Examples of silicon-based compounds comprise siloxane compounds, such as methylsiloxane, methylsilsesquioxane, phenylsiloxane, phenylsilsesquioxane, methylphenylsiloxane, methylphenylsilsesquioxane, silazane polymers, silicate polymers and mixtures thereof. Examples of siloxane polymers and blockpolymers include hydrogensiloxane polymers of the general formula (H_{0-1.0}SiO_{1.5-2.0})ₓ and hydrogensilsesquioxane polymers, which have the formula (HSiO_{1.5})ₓ, where x is greater than about four. Also included are copolymers of hydrogensilsesquioxane and an alkoxyhydridosiloxane or hydroxyhydridosiloxane. Several of the contemplated vapor deposition and spin-on materials are described in the following issued patents and pending applications, which are herein incorporated by reference in their entirety: (PCT/US00/15772 filed Jun. 8, 2000; U.S. application Ser. No. 09/330248 filed Jun. 10, 1999; U.S. application Ser. No. 09/491166 filed Jun. 10, 1999; U.S. Pat. No. 6,365,765 issued on Apr. 2, 2002; U.S. Pat. No. 6,268,457 issued on Jul. 31, 2001; U.S. application Ser. No. 10/001143 filed Nov. 10, 2001; U.S. application Ser. No. 09/491166 filed Jan. 26, 2000; PCT/US00/00523 filed Jan. 7, 1999; U.S. Pat. No. 6,177,199 issued Jan. 23, 2001; U.S. Pat. No. 6,358,559 issued March 19, 2002; U.S. Pat. No. 6,218,020 issued Apr. 17, 2001; U.S. Pat. No. 6,361,820 issued Mar. 26, 2002; U.S. Pat. No. 6,218,497 issued Apr. 17, 2001; U.S. Pat. No. 6,359,099 issued Mar. 19, 2002; U.S. Pat No. 6,143,855 issued Nov. 7, 2000; and U.S. application Ser. No. 09/611528 filed Mar. 20, 1998).

TEOS, for example, can also be a component of or incorporated into contemplated sacrificial anti-reflective and absorbing coating materials for ultraviolet photolithography, such as those disclosed in PCT applications PCT/US02/36327 filed on Nov. 12, 2002; PCT/US03/36354 filed on Nov. 12, 2003 and in U.S. application Ser. No. 10/717028 filed on Nov. 18, 2003. These sacrificial materials are also disclosed in U.S. Pat. Nos.: 6,268,457, 6,365,765, and U.S. Ser. Nos.: 10/076846, 10/300357 and 11/178544, which are all commonly-owned and incorporated herein in their entirety.

Methods of forming and uses of these removal chemistries are also contemplated and described herein. Such methods include providing the constituents of the removal chemistry formulation, blending the constituents to form the formulation and applying the formulation to a surface or substrate. In some embodiments, the formulation may be produced in situ (directly on the surface) or may be formed before application to the surface.

The removal chemistry solution may be applied to a semiconductor wafer post photoresist deposition (may be pre or post lithography) for wafer rework purposes in either a single wafer or batch processing tool for a period of time between about 15 seconds and about 100 minutes. Processing temperature may be from about 20° C. up to about 80° C. The wafer may be dipped into solution once and held for a particular time period or dipped multiple times, may be rinsed by the solution, may have the solution applied in a methodical patterned form, may be masked and then rinsed by the solution, etc.

The removal chemistry solution may also be held at a particular temperature which optimizes the removal abilities of the solution or may be varied with respect to temperature depending on the wafer or surface. The term “varied” is used herein with respect to temperature to mean that the solution temperature may be varied while the wafer is being processed or may be varied from wafer to wafer depending on the extent of residue that needs to be removed. In some contemplated embodiments, the temperature of the removal chemistry solution is held at less than about 80° C. In other contemplated embodiments, the temperature of the removal chemistry solution is held at less than about 50° C. In yet other contemplated embodiments, the temperature of the removal chemistry solution is held at about 30° C.

In a single wafer tool, removal chemistry solutions may also be applied as a puddle on a stationary wafer which is then rotated at a set speed. Alternately, the removal chemistry solution may be applied as a spray to a wafer that is rotating, either with dispensing occurring at the center of the wafer only, or having a dispense head that moves from the center position to the edge of the wafer, or having multiple fixed dispense heads that are spaced evenly from center to edge of wafer. For batch processing, wafers are immersed in a tank of removal chemistry solution, and turbulence is created with agitation, ultrasonics/megasonics and/or air bubbling.

Samples may be pretreated before application of removal chemistry solution. Pretreatment can include applying a liquid or vapor to the wafer surface to improve wetting when the removal chemistry solution is applied. Also pretreatment may include application of liquid or vapor to the wafer surface to chemically modify the surface to increase effectiveness/improve selectivity of removal chemistry solution.

Wafers and layered materials contemplated herein comprise those wafers and layered materials that are utilized or considered to be utilized in semiconductor or electronic applications, such as dual damascene structures, and comprise at least one layer of material. Surfaces contemplated herein may comprise any desirable substantially solid material, such as a substrate, wafer or other suitable surface. Particularly desirable substrate layers would comprise films, organic polymer, inorganic polymer, glass, ceramic, plastic, metal or coated metal, or composite material. Surface and/or substrate layers comprise at least one layer and in some instances comprise a plurality of layers. In other embodiments, the substrate comprises a material common in the integrated circuit industries as well as the packaging and circuit board industries such as silicon, copper, glass, and another polymer. Suitable surfaces contemplated herein may also include another previously formed layered stack, other layered component, or other component altogether. An example of this may be where a dielectric material and CVD barrier layer are first laid down as a layered stack—which is considered the “surface” for the subsequently spun-on layered component.

Therefore, as described herein and as shown by the following examples, selective removal chemistry solutions have been developed that can do at least one of the following: a) can be tailored to be a selective etching solution and/or a selective cleaning solution; b) is effective in removing organic materials, which may be used as anti-reflective coatings (including bottom coatings) and which are traditionally very difficult to remove with wet chemical processing; c) can selectively remove deleterious materials and compositions from a surface without removing the layers and materials that are crucial to product success, such as the underlying dielectric layers; d) can remove the desired materials from the surface, while at the same time minimizing or eliminating redeposition of those materials on the surface; and e) can etch and/or clean effectively at the center of the wafer or surface and at the edge of the wafer or surface.

### EXAMPLES

### Removal of Organic Polymer Films that can be Used as Bottom Anti-Reflective Coatings (“BARCS”) Using Removal Chemistry Solution Containing Methanesulfonic Acid

Procedure:

Samples of blanket and patterned organic polymer films were cleaved into approximately 2 cm×1 cm pieces. Organic polymer films had pre-thickness measurements taken using Filmetrics F20 reflectometer. Patterned samples had representative pre-pictures taken at 40× magnification using a Nikon laboratory microscope.

Mixtures tested were created by blending 5.11% HF in propylene carbonate (PC) stock with at least one additive, such as oxidizers, amines, etc. in weight percentage (wt %) and pure propylene carbonate (Huntsman; UltraPure™) to give desired final concentrations of HF and additives. Samples were either mixed using a magnetic stirrer and TEFLON-coated stirbar or agitated using VWR ultrasonic cleaner heated to 60° C., depending on solubility of the additive.

Samples were exposed to solutions without any form of agitation for a period of 10 minutes at either 40 or 60° C. Samples were then placed in a beaker of deionized (DI) water to quench the reaction, rinsed 3 times with DI water and dried with compressed dry air (CDA). The solutions utilized and the results are shown in Table 1.

Post-treatment thickness measurements for blanket films were taken with the Filmetrics F20 reflectometer or microscope, and post-exposure pictures were taken for the patterned sample using a Nikon laboratory microscope.

TABLE 1

| | | | | | | Organic film | |
|---|---|---|---|---|---|---|---|
| | | | | | | useful as ARC | |
| | | OSG | | TEOS | | or BARC | |
| | Temp. | Pre-Etch | Post-Etch | Pre-Etch | Post-Etch | Pre-Etch | Post-Etch |
| Composition | (° C.) | (Angstroms) | (Angstroms) | (Angstroms) | (Angstroms) | (Angstroms) | (Angstroms) |
| 100% MSA | 60 | 4305 | 4335 | 1015 | 1023 | 932.9 | 0 |
| 0.025% HF in | 60 | 4329 | 4363 | 1039 | 1062 | 905.7 | 0 |
| PC | | | | | | | |
| 10% MSA | | | | | | | |
| 85% γ- | | | | | | | |
| butyrolactone | | | | | | | |
| (BLO) | | | | | | | |
| 10% MSA | 60 | 4348 | 4350 | Not Tested | Not | 924.5 | 0 |
| 10% HOAc | | | | | Tested | | |
| 80% PC | | | | | | | |
| 10% MSA | 60 | Not Tested | Not | Not Tested | Not | 913.5 | 0 |
| 10% HOAc | | | Tested | | Tested | | |
| 80% BLO | | | | | | | |

In the study summarized by Table 2, methanesulfonic acid was used (Aldrich; 99.5%), but it should be understood that other sulfonic acids can be utilized, such as ethanesulfonic acid, propanesulfonic acid, fluorosulfonic acid, trifluoromethylsulfonic acid, benzene sulfonic acid, sulfamic acid, sulfanilic acid and other organic sulfonic acids of the form R—SO₃—H, wherein R comprises at least one halo group, amino group, alkyl group, alkenyl group, alkynyl group or phenylamino group having the formula C₆(NH₂)H₂XY, where X and Y may comprise at least one hydrogen, halo group, alkyl group, alkenyl group, alkynyl group, hydroxyl group, amino group or phenyl group. R may also comprise R₁R₂R₃C, where R₁, R₂ and R₃ may be the same or different and may comprise at least one hydrogen, halo group, alkyl group, alkenyl group, alkynyl group, hydroxyl group, amino group or aromatic group, and at least one solvent or solvent mixture. Combinations of sulfonic acids may also be used.

Glacial acetic acid (HOAc) and γ-butyrolactone (Aldrich, 99+% purity) were also used, along with the propylene carbonate previously disclosed. The results are shown in Table 2:

| Weight | | | | | | | Organic film | |
|---|---|---|---|---|---|---|---|---|
| Added | | | | | | | useful as | |
| | Methane- | | | | | | BARC or | |
| | sulfonic | | OSG | | TEOS | | ARC | |
| 5% PC- | acid | | Pre-Etch | Post-Etch | Pre-Etch | Post-Etch | Pre-Etch | Post-Etch |
| HF | (MSA) | PC | (Angstroms) | (Angstroms) | (Angstroms) | (Angstroms) | (Angstroms) | (Angstroms) |
| 5 | 10 | 85 | 4325 | 4339 | 1055 | 1052 | 906.2 | 0 |

Comparative studies were conducted using solutions that did not contain an organic sulfonic acid, and it was shown that the solutions had little effect on the organic films or crusts.

Thus, specific embodiments and applications of selective etching and cleaning solutions for semiconductor and electronic applications, including selectively removing organic materials, such as anti-reflective coatings, bottom anti-reflective coatings, photoresists and post ash/post etch residues, the production of these solutions and uses thereof have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized or combined with other elements, components, or steps that are not expressly referenced.

We claim:

1. A removal chemistry solution comprising:
at least one sulfonic acid component having the formula:
R—SO₃H (Formula I)
where R comprises at least one halo group, amino group, alkyl group, alkenyl group, alkynyl group or phenylamino group having the formula C₆(NH₂)H₂XY, where X and Y may comprise at least one hydrogen, halo group, alkyl group, alkenyl group, alkynyl group, hydroxyl group, amino group or phenyl group, and at least one solvent or solvent mixture.

2. The removal chemistry solution of claim 1, wherein R may also comprise R₁R₂R₃C, where R₁, R₂ and R₃ may be the same or different and may comprise at least one hydrogen, halo group, alkyl group, alkenyl group, alkynyl group, hydroxyl group, amino group or aromatic group.

3. The removal chemistry solution of claim 1, wherein the at least one sulfonic acid component comprises an alkylsulfonic acid, an alkylsulfonic anhydride or a combination thereof.

4. The removal chemistry solution of claim 3, wherein the at least one alkylsulfonic acid comprises methanesulfonic acid, ethanesulfonic acid, propanesulfonic acid, fluorosulfonic acid, trifluoromethanesulfonic acid, nonafluorobutanesulfonic acid, sulfanilic acid, sulfamic acid, aminomethanesulfonic acid, benzenesulfonic acid, morpholine ethanesulfonic acid, morpholine propanesulfonic acid, camphor-10-sulfonic acid, diphenylamine-4-sulfonic acid, hydroxylamine-O-sulfonic acid, 4-hydroxy-3-nitroso-1-napthalenesulfonic acid, 5-amino-1-napthalenesulfonic acid, 4-aminotoluenesulfonic acid, 3-hydroxypropane-1-sulfonic acid, 4-amino-1-napthalenesulfonic acid, 4-amino-3-hydroxy-1-napthalenesulfonic acid, 1-aminoanthaquinone-2-sulfonic acid, p-xylenen-2-sulfonic acid, piperidine-4-sulfonic acid or combinations thereof.

5. The removal chemistry solution of claim 3, wherein the at least one alkylsulfonic anhydride comprises methanesulfonic anhydride, trifluoromethanesulfonic anhydride or a combination thereof.

6. The removal chemistry solution of claim 1, further comprising at least one fluoride source.

7. The removal chemistry solution of claim 6, wherein the at least one fluoride source comprises hydrogen fluoride, R₁R₂R₃R₄NF, where R₁, R₂, R₃ and R₄ can be the same or different and can be H or any hydrocarbon moiety of 10 or less carbon units and may be aliphatic, aromatic or cyclic or a combination thereof.

8. The removal chemistry solution of claim 6, wherein the at least one fluoride source comprises ammonium fluoride, tetramethylammonium fluoride, tetrabutylammonium fluoride, tetraethylammonium fluoride or benzyltrimethylammonium fluoride; hydrogen fluoride, pyridine hydrogen fluoride, ammonium bifluoride or combinations thereof

9. The removal chemistry solution of claim 7, wherein hydrogen fluoride is obtained from 49% aqueous hydrogen fluoride, anhydrous hydrogen fluoride gas, pyridinium hydrogen fluoride or combinations thereof.

10. The removal chemistry solution of claim 1, wherein the at least one solvent or solvent mixture comprises propylene carbonate, butylene carbonate, ethylene carbonate, gamma-butyrolactone, propylene glycol, ethyl lactate, propylene glycol monomethyl ether acetate N-methyl-2-pyrrolidone, N,N-dimethylacetamide, dimethyl sulfoxide, pyridine or a combination thereof.

11. The removal chemistry of claim 1, further comprising at least one oxidizing agent, chelator, surfactant or a combination thereof.

12. The removal chemistry solution of claim 1, wherein the solution is used to selectively remove organic materials, which are suitable for anti-reflective coatings.

13. The removal chemistry solution of claim 12, wherein the organic material is an anti-reflective coating.

14. The removal chemistry solution of claim 1, wherein the pH of the solution is less than about 5.

15. The removal chemistry solution of claim 1, wherein the flash point of the solution is greater than about 200° F.

16. The removal chemistry solution of claim 1, wherein the solution selectively removes an organic polymer film at a rate of at least 90 Å/minute.

17. The removal chemistry solution of claim 16, wherein the organic polymer film comprises an anti-reflective coating.

18. The removal chemistry solution of claim 1, comprising methanesulfonic acid, propylene carbonate, γ-butyrolactone and hydrogen fluoride.

19. A method of producing a removal chemistry solution, comprising:
providing at least one sulfonic acid component having the formula:
R—SO₃H (Formula I)
where R comprises at least one halo group, amino group, alkyl group, alkenyl group, alkynyl group or phenylamino group having the formula C₆(NH₂)H₂XY, where X and Y may comprise at least one hydrogen, halo group, alkyl group, alkenyl group, alkynyl group, hydroxyl group, amino group or phenyl group;
providing at least one solvent or solvent mixture; and
blending the at least one sulfonic acid component and the at least one solvent or solvent mixture to form the removal chemistry solution.

20. The method of claim 19, wherein R may also comprise R₁R₂R₃C, where R₁, R₂ and R₃ may be the same or different and may comprise at least one hydrogen, halo group, alkyl group, alkenyl group, alkynyl group, hydroxyl group, amino group or aromatic group.

21. The method of claim 19, wherein the at least one sulfonic acid component comprises an alkylsulfonic acid, an alkylsulfonic anhydride or a combination thereof.

22. The method of claim 19, further comprising providing at least one fluoride source.

23. The method of claim 22, wherein the at least one fluoride source comprises hydrogen fluoride, R₁R₂R₃R₄NF, where R₁, R₂, R₃ and R₄ can be the same or different and can be H or any hydrocarbon moiety of 10 or less carbon units and may be aliphatic, aromatic orcyclic or a combination thereof.

24. The method of claim 22, wherein the at least one fluoride source comprises ammonium fluoride, tetramethylammonium fluoride, tetrabutylammonium fluoride, tetraethylammonium fluoride or benzyltrimethylammonium fluoride; hydrogen fluoride, pyridine hydrogen fluoride, ammonium bifluoride or combinations thereof.

25. The method of claim 19, wherein the at least one solvent or solvent mixture comprises propylene carbonate, butylene carbonate, ethylene carbonate, gamma-butyrolactone, propylene glycol, ethyl lactate, propylene glycol monomethyl ether acetate N-methyl-2-pyrrolidone, N,N-dimethylacetamide, dimethyl sulfoxide, pyridine or a combination thereof.

26. The method of claim 19, further comprising providing at least one of an oxidizing agent, a chelator, a surfactant or a combination thereof.
